(19) United States
(12) Patent Application Publication
(10) Pub. No.: US 2024/0329856 A1
(43) Pub. Date: Oct. 3, 2024

(54) SHADOW MAP FOR IDENTIFYING BAD FREE BITS AND DUPLICATE REFERENCES IN A FILE SYSTEM

(71) Applicant: International Business Machines Corporation, Armonk, NY (US)

(72) Inventors: Karthik Iyer, Bangalore (IN); Frank Schmuck, Campbell, CA (US)

(21) Appl. No.: 18/191,672

(22) Filed: Mar. 28, 2023

(51) Int. Cl. G06F 3/06

(52) U.S. Cl. CPC G06F 3/0619; G06F 3/0641; G06F 3/0652; G06F 3/0683

(57) ABSTRACT

Methods that utilize a shadow map to identify bad free bits and duplicate references in a file system are disclosed herein. One method includes a processor generating a shadow map of a file system and utilizing the shadow map to identify bad free bits in a block allocation map of the file system and/or utilizing the shadow map to identify duplicate references in the file system. Also disclosed herein are apparatus, systems, and computer program products that can include, perform, and/or implement the methods for utilizing a shadow map to identify bad free bits and/or duplicate references in a file system.

### FIELD

The subject matter disclosed herein relates to data storage and, more particularly, relates to a shadow map for identifying bad free bits and duplicate references in a file system.

### BACKGROUND

Contemporary file systems typically keep track of used and free storage blocks via a bitmap stored as part of a file system called, a block allocation map. A block allocation map typically contains one bit for every storage block of its file system and each bit indicates whether a storage block is in use (e.g., is storing data) by a data file. Generally, a block allocation map is used to find a free storage block when adding a new storage block to a data file or directory of its file system.

Contemporary block allocation maps can become inconsistent due to various error events (e.g., undetected hardware and/or software errors in an underlying storage subsystem). One such inconsistency can include a block allocation map indicating and/or marking one or more storage blocks as free and/or available for storing data even though the storage block is in use (e.g., storing data) by another data file in the file system or is otherwise unavailable for storing new data. This inconsistent condition on a block allocation map is often referred to as, a bad free bit.

A result of a block allocation map including a bad free bit can include a data file reusing a storage block that is already being used by another data file by overwriting the data currently stored by the other data file in the storage block, which can lead to the data of the other data file becoming corrupted. In addition, overwriting the data currently stored by the other data file in the storage block may be a security concern because the data of one data file can become visible to another data file across access boundaries. The condition in which a single storage block is referenced by more than one data file (or multiple logical locations within the same data file) is often referred to as, a duplicate reference, and the corresponding storage block is often referred to as, a duplicate storage block.

### BRIEF SUMMARY

Apparatus and/or systems that utilize a shadow map to identify bad free bits and duplicate references in a file system are disclosed herein. One apparatus and/or system includes a shadow map module that generates a shadow map of a file system and further includes an error module that utilizes the shadow map to identify bad free bits in a block allocation map of the file system and/or a shadow map module that utilizes the shadow map to identify duplicate references in the file system.

Methods that utilize a shadow map to identify bad free bits and duplicate references in a file system are also provided. One method includes generating, by a processor, a shadow map of a file system, utilizing the shadow map to identify bad free bits in a block allocation map of the file system, and/or utilizing the shadow map to identify duplicate references in the file system.

Also disclosed herein are computer program products including a computer-readable storage medium including program instructions embodied therewith that can utilize a shadow map to identify bad free bits and duplicate references in a file system. The program instructions are executable by a processor and cause the processor to generate a shadow map of a file system, utilize the shadow map to identify bad free bits in a block allocation map of the file system, and/or utilize the shadow map to identify duplicate references in the file system.

### BRIEF DESCRIPTION OF THE DRAWINGS

So that at least some advantages of the technology may be readily understood, more particular descriptions of the embodiments briefly described above are rendered by reference to specific embodiments that are illustrated in the appended drawings. Understanding that the drawings included herein only depict some embodiments, the embodiments discussed herein are therefore not to be considered as limiting the scope of the technology. That is, the embodiments of the technology that are described and explained herein are done with specificity and detail utilizing the accompanying drawings, in which:

FIG. 1 is a block diagram of one embodiment of a system that can utilize a shadow map to identify bad free bits and duplicate references in a file system;

FIG. 2 is a block diagram of one embodiment of a storage system included in the system of FIG. 1;

FIGS. 3A through 3C are block diagrams of various embodiments of a storage device included in the storage system of FIG. 2;

FIGS. 4A and 4B are block diagrams of various embodiments of a processor included in the storage system of FIG. 2;

FIG. 5 is a schematic flow chart diagram illustrating one embodiment of a method that can utilize a shadow map to identify bad free bits in a file system;

FIG. 6 is a schematic flow chart diagram illustrating another embodiment of a method that can utilize a shadow map to identify bad free bits in a file system;

FIG. 7 is a schematic flow chart diagram illustrating one embodiment of a method that can utilize a shadow map to identify duplicate references in a file system;

FIG. 8 is a schematic flow chart diagram illustrating another embodiment of a method that can utilize a shadow map to identify duplicate references in a file system; and

FIG. 9 is a schematic flow chart diagram illustrating an embodiment of a method that can utilize a shadow map to identify bad free bits and duplicate references in a file system.

### DETAILED DESCRIPTION

Disclosed herein are various embodiments providing apparatus, systems, computer program products, and methods that can utilize a shadow map to identify bad free bits and duplicate references in a file system. Notably, the language used in the present disclosure has been principally selected for readability and instructional purposes, and not to limit the scope of the subject matter disclosed herein in any manner.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “including,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more,” unless expressly specified otherwise.

In addition, as used herein, the term “set” can mean “one or more,” unless expressly specified otherwise. The term “sets” can mean multiples of or a plurality of “one or mores,” “ones or more,” and/or “ones or mores” consistent with set theory, unless expressly specified otherwise.

Further, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present technology may be a system, a method, and/or a computer program product. The computer program product may include a computer-readable storage medium (or media) including computer-readable program instructions thereon for causing a processor to carry out aspects of the present technology.

The computer-readable storage medium may be a tangible device that can retain and store instructions for use by an instruction execution device. The computer-readable storage medium may be, but is not limited to, for example, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove including instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). To perform aspects of the present technology, in some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry.

Aspects of the present technology are described herein with reference to flowchart illustrations and/or block diagrams of methods, apparatus (systems), and computer program products according to embodiments of the technology. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium including instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

To more particularly emphasize their implementation independence, many of the functional units described in this specification have been labeled as modules. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together and may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure below may refer to elements of proceeding figures. For instance, like numbers can refer to similar elements in all figures, including alternate embodiments of similar elements.

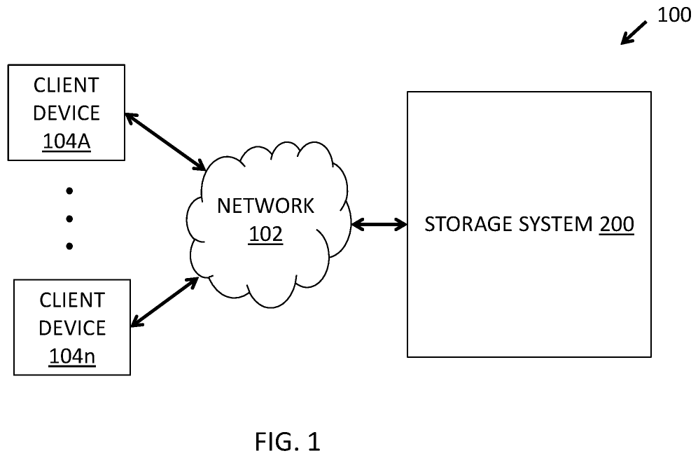

With reference now to the drawings, FIG. 1 is a block diagram of one embodiment of a computing network 100 (or system) that can utilize a shadow map to identify bad free bits and duplicate references in a file system. At least in the illustrated embodiment, the computing network 100 includes a network 102 connecting a set of one or more client devices 104A through 104n (also simply referred individually, in various groups, or collectively as client device(s) 104) and a storage system 200.

The network 102 may include any suitable wired and/or wireless network 102 (e.g., public and/or private computer networks in any number and/or configuration (e.g., the Internet, an intranet, a cloud network, etc.)) that is known or developed in the future that enables the set of client devices 104 and the storage system 200 to be coupled to and/or in communication with one another and/or to share resources. In various embodiments, the network 102 can include a cloud network (IAN), a SAN (e.g., a storage area network, a small area network, a server area network, and/or a system area network), a wide area network (WAN), a local area network (LAN), a wireless local area network (WLAN), a metropolitan area network (MAN), an enterprise private network (EPN), a virtual private network (VPN), and/or a personal area network (PAN), among other examples of computing networks and/or or sets of computing devices connected together for the purpose of sharing resources that are possible and contemplated herein.

A client device 104 can include any suitable computing hardware and/or software (e.g., a thick client, a thin client, or hybrid thereof) capable of accessing the storage system 200 via the network 102. Each client device 104, as part of its respective operation. relies on sending I/O requests to the storage system 200 to write data, read data, and/or modify data. Specifically, each client device 104 can transmit I/O requests to read, write, store, communicate, propagate, and/or transport instructions, data, computer programs, software, code, routines, etc., to the storage system 200 and may include at least a portion of a client-server model. In general, the storage system 200 can be accessed by the client device(s) 104 and/or communication with the storage system 200 can be initiated by the client device(s) 104 through a network socket (not shown) utilizing one or more inter-process networking techniques.

While the computing network 100 illustrated in FIG. 1 includes two (2) client devices 104 (e.g., client devices 104A and 104n), the various embodiments of the computing network 100 are not limited to two client devices 104. That is, a computing network 100 may include one (1) client device 104 or a quantity of client devices 104 that is greater than two client devices 104. In other words, various other embodiments of the computing network 100 may include any suitable of quantity of client devices 104.

A storage system 200 may include any suitable hardware and/or software capable of performing data storage processes, functions, and/or algorithms, as discussed elsewhere herein. In various embodiments, a storage system 200 may include any suitable computing storage system and/or computing storage device that can store computer-readable data and/or computer-usable data. In some embodiments, the storage system 200 includes hardware and/or software configured to execute instructions in one or more modules and/or applications for identifying duplicate references in a file system and deleting data from corresponding duplicate storage blocks, as discussed elsewhere herein.

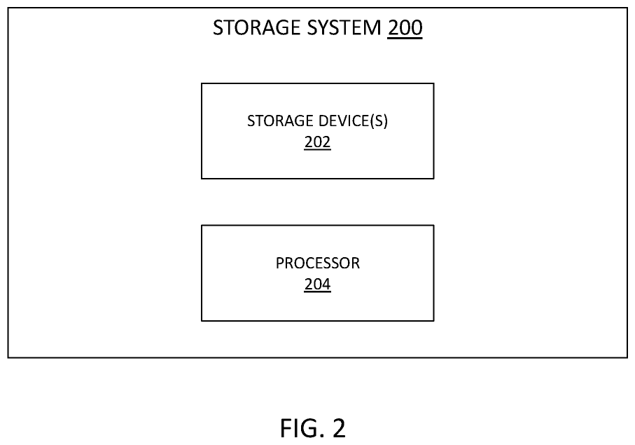

Referring to FIG. 2, FIG. 2 is a block diagram of one embodiment of a storage system 200 that can utilize a shadow map to identify bad free bits and duplicate references in a file system. At least in the illustrated embodiment, the computing system 200 includes, among other components, a set of storage devices 202 and processor 204.

A set of storage devices 202 may include any suitable quantity of storage devices 202 that can store data for a particular application, function, and/or use. Further, each storage device 202 may include any suitable size and/or storage capacity that is known or developed in the future.

In addition, a storage device 202 may include any type of memory device that is known or developed in the future that is capable of storing data. The storage device(s) 202, in various embodiments, can include and/or store a set of one or more data files storing data therein.

In various embodiments, a storage device 202 may include one or more non-transitory computer-usable mediums (e.g., readable, writable, etc.), which can include any non-transitory and/or persistent apparatus or device that can contain, store, communicate, propagate, and/or transport instructions, data, computer programs, software, code, routines, etc., for processing by or in connection with a computer processing device (e.g., the processor 204). Further, a storage device 202 may include non-volatile/persistent hardware and/or software configured to perform long-term data storage operations, including, but not limited to, data archiving, data backup, data mirroring, and/or data replicating data, etc., among other long-term data storage operations that are possible and contemplated herein. For instance, a storage device 202 may include non-volatile and/or persistent hardware and/or software configured for performing long-term data storage operations, which may include write operations, read operations, and/or read-write operations, etc., among other storage operations that are possible and contemplated herein.

In various embodiments, the storage device(s) 202 can be implemented as flash memory (e.g., a solid-state device (SSD) or other non-volatile storage devices that store persistent data). Further, a storage device 202, in some embodiments, may include non-transitory memory such as, for example, a dynamic random-access memory (DRAM) device, a static random-access memory (SRAM) device, a hard disk drive (HDD), storage tape (e.g., magnetic and/or virtual), and/or other types (e.g., non-volatile and/or persistent) of memory devices, etc., among other types of non-transitory memory that are possible and contemplated herein.

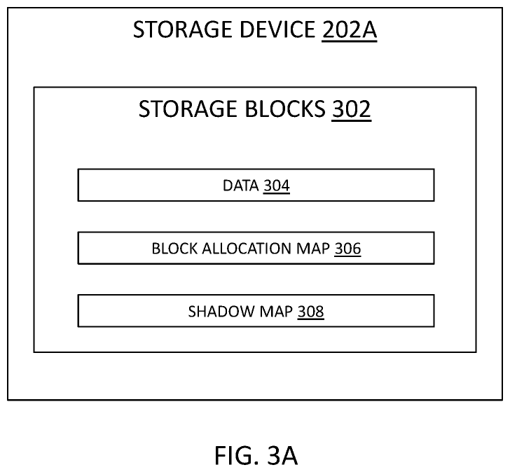

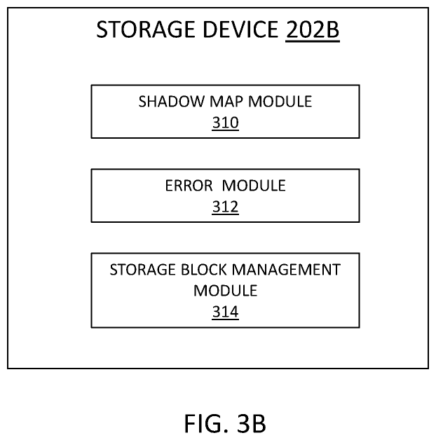

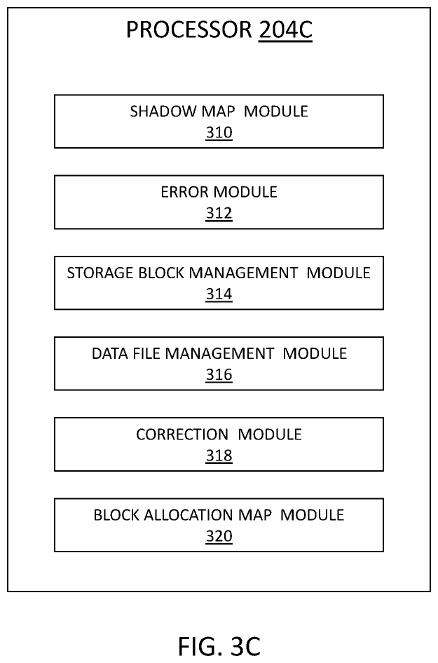

One embodiment of a storage device 202A is illustrated in FIG. 3A. At least in the embodiment illustrated in FIG. 3A, a storage device 202A is divided into a set of storage blocks 302 storing, among other elements, data 304, a block allocation map 306, and a shadow map 308.

A storage block 302 can include any suitable memory cell or group of memory cells that is known or developed in the future. Further, a storage block 302 can include any suitable type and/or size of storage block that is known or developed in the future capable of storing data. In addition, a set of memory blocks 302 may include any suitable quantity of storage blocks 302 for a particular memory system, memory device, and/or application of memory.

The set of memory blocks 302 is configured to store the data 304, the block allocation map 306, and the shadow map 308. The data 304 may include any suitable type of data in any type of format that is known or developed in the future.

A block allocation map 306 may include any suitable storage block mapping mechanism, schema, and/or process that is known or developed in the future. In various embodiments, a block allocation map 306 can include at least a portion of a bitmap and/or form at least a portion of a bitmap.

In certain embodiments, the block allocation map 306 is configured to track the allocation of storage blocks 302. That is, the block allocation map 306 is configured track, indicate, and/or identify which storage block(s) 302 is/are not currently storing data 304 and an indication (e.g., a positive indication or by default) which storage block(s) 302 are storing data 304 and is/are not currently available to store data 304 for another data file.

In various embodiments, the block allocation map 306 is updated as the availability of the storage block(s) 302 changes. For example, the block allocation map 306 is updated to indicate that a storage block 302 is available for storing data 304 in response to the data 304 within the storage block 302 being deleted. Similarly, the block allocation map 306 is updated to indicate that a storage block 302 is not available for storing data 304 in response to data 304 being written to and/or stored in the storage block 302.

A shadow map 308 may include any suitable storage block mapping mechanism, schema, and/or process that is known or developed in the future. In certain embodiments, a shadow map 308 can include at least a portion of a bitmap and/or form at least a portion of a bitmap.

In various embodiments, the shadow map 308 is configured to duplicate and/or shadow the block allocation map 306. In other words, the shadow map 308 can function similar to the block allocation map 306. That is, the shadow map 308 is configured to track, indicate, and/or identify which storage block(s) 302 is/are currently storing data 304 and also track, indicate, and/or identify which storage block(s) 302 is/are not currently storing data 304.

The shadow map 308, in various embodiments, can be used to identify one or more bad free bits in the block allocation map 306. That is, the shadow map 308 can be utilized to identify one or more bits (including each bit) in the block allocation map 306 that indicate that its corresponding storage block 302 is available for storing data 304 when in fact the storage block 302 is already being used by a data file to store data 304 therein, as discussed elsewhere herein.

In additional or alternative embodiments, the shadow map 308 can be used to identify one or more duplicate references. That is, the shadow map 308 can be utilized to identify one or more bits (including each bit) in the block allocation map 306 that is being referenced by multiple data files (e.g., two or more data files), as discussed elsewhere herein.

In further additional or alternative embodiments, the shadow map 308 can be used to identify one or more duplicate storage blocks 302. That is, the shadow map 308 can be utilized to identify one or more storage blocks 302 (including each storage block 302) that is being referenced by multiple data files (e.g., two or more data files), as discussed elsewhere herein.

In various embodiments, the shadow map 308 is filled in for each data file storing data 304 in the storage device(s) 202. In certain embodiments, each data file is mapped to the shadow map 308 one data file at a time so that the file system on the storage device(s) 202 remains mounted while the file system is being checked for bad free bits, duplicate references, and/or duplicate storage blocks, as discussed elsewhere herein. In additional embodiments, the shadow map 308 is updated in real-time and/or on-the-fly in response to determining that a data file that has already been mapped to the shadow map 308 is now using one or more additional data blocks 302 (e.g., has had new data 304 written to one or more new data blocks 302), is now using one or more different data blocks 302 (e.g., has had old data 304 written to one or more new data blocks 302), and/or is now no longer using one or more storage blocks 302 (e.g., has had data 304 deleted from the storage block(s) 302), as discussed elsewhere herein.

One embodiment of a storage device 202B is illustrated in FIG. 3B. At least in the embodiment illustrated in FIG. 3B, a storage device 202B includes, among other elements, a shadow map module 310, an error module 312, and a storage block management module 314.

A shadow map module 310 may include any suitable hardware and/or software that can generate a shadow map 308 and fill in the shadow map 308. In filling in the shadow map 308, the shadow map module 310 is configured to map each storage block 302 in the storage device(s) 202 to a corresponding bit in the shadow map 308. In various embodiments, mapping to the shadow map 308 includes providing an indication of which storage block(s) 302 are currently being used and/or an indication of which storage block(s) 302 are not currently being used by a data file and are available for use by a data file.

To fill in the shadow map 308, various embodiments of the shadow map module 310 are configured to map the storage blocks 302 used by each data file to the shadow map 308. In certain embodiments, the shadow map module 310 is configured to map each data file to the shadow map 308 one data file at a time so that the file system on the storage device(s) 202 can remain mounted while the block allocation map 306 is checked for bad free bits and/or the file system is checked for duplicate references and/or duplicate storage blocks 302.

In mapping the data files to the shadow map 308 one at a time, in some embodiments, the shadow map module 310 is configured to select each data file one at a time for mapping. Further, when selected for mapping, each data file is locked so that the locked data file cannot be modified while the storage block(s) 302 that is/are being used by the locked data file is/are being mapped to the shadow map 308. Here, the metadata included in each data file identifies which storage blocks 302 are being used by each particular data file to store data 304.

In addition, the shadow map module 310 is configured to unlock/release each locked data file after it is mapped to the shadow map 308. This locking/unlocking process is repeated by the shadow map 308 until each data file on the fie system is mapped to the shadow map 308.

In various embodiments, in mapping the data files to the shadow map 308, the mapping module 310 is configured to turn ON a bit in the shadow map 308 corresponding to a particular storage block 302 on the storage device(s) 202 to indicate that the particular storage block 302 is being used by a data file and/or is not available for storing data 304. Here, a bit in the shadow map 308 that is OFF can indicate that the corresponding storage block 302 on a storage device 202 is not being used by a data file and is available for use by a data file to store data 304.

In various embodiments, while filling in the shadow map 308 the shadow map module 310 is configured to identify and/or determine duplicate references and/or duplicate storage blocks 302. Here, a duplicate reference and/or duplicate storage block 302 can be identified and/or determined using the shadow map 308 when the shadow map module 310 goes to turn ON the bit in the shadow map 308 corresponding to a particular storage block 302 indicated in the metadata for a data file that is currently being mapped to the shadow map 308 and the bit is already turned ON and/or has been previously turned ON. That is, a bit in the shadow map 308 that has been previously turned ON is an indication that the metadata for a previously mapped data file is referencing the same storage block 302 as the metadata for a data file that is currently being mapped to the shadow map 308. Specifically. the metadata of the data file that is currently being mapped to the shadow map 308 is referencing the same storage block 302 that the metadata of at least one previously mapped data file is also referencing. In other words, two or more data files include an indication that they are using the same storage block 302 to store data 304.

The shadow map module 310, in various embodiments, is configured to tag and/or flag any bits in the shadow map 308 that are being referenced by multiple (e.g., two or more) different data files. For example, the shadow map module 310 is configured to tag and/or flag any bit in the shadow map 308 that corresponds to a storage block 302 referenced in the metadata in the data file that is currently being mapped to the shadow map 308 and that bit in the shadow map 308 is already turned ON indicating that the corresponding storage block 302 is being referenced by the metadata of a data file that has previously been mapped to the shadow map 308. In other words, there is a storage block conflict because the metadata of two or more different data files are referencing the same storage block 302 resulting in a duplicate reference in the shadow map 308 and/or a duplicate storage block 302.

In certain embodiments, the shadow map module 310 is configured to transmit a notification to the storage block management module 314 in response to identifying/determining a duplicate reference in the shadow map 308 and/or identifying/determining a duplicate storage block 302. The notification can identify each duplicate storage block 302 (e.g., each tagged/flagged storage block 302) and further include a command instructing the storage block management module 314 to prevent the duplicate storage block 302 (e.g., the storage block 302 being referenced by two different data files) from being made available and/or becoming available for reuse while the shadow map module 310 is filling in the shadow map 308, as discussed elsewhere herein.

To prevent the duplicate storage block 302 from being reused, the storage block management module 314 checks whether the duplicate storage block 304 is marked as in use in the block allocation map 306 and, if necessary, updates the block allocation map 306 to mark the duplicate storage block 302 as being in use and disallows further updates to the corresponding bit in the block allocation map 306 until all duplicate references have been removed. Since the block allocation map 306 is used to find unused storage blocks 302 for re-use, preventing changes to the bit in the block allocation map 306 prevents the storage block 302 from being reused.

While filling in the shadow map 308, the shadow map module 310, in certain embodiments, is configured to receive a notification each time that a data file in the file system is modified to include one or more additional storage blocks 302 and/or is no longer using one or more data blocks 302 (e.g., released storage block(s) 302). In response to receiving the notification, the shadow map module 310 is configured to determine whether the modified data file has already been mapped to the shadow map 308.

The shadow map module 310 is configured to update the shadow map 308 with the modification(s) (e.g., the additional storage block(s) 302 and/or released storage block(s) 302) in response to determining that the modified data file has been mapped to the shadow map 308. Here, the data file is locked while it is being modified and the modification(s) are mapped to the shadow map 308 and the modified data file is unlocked/released in response to the modification(s) being mapped to the shadow map 308.

Further, the shadow map module 310 is configured to ignore and/or do nothing (e.g., not map the modified data file to the shadow map 308) in response to determining that the modified data file has not yet been mapped to the shadow map 308 since the modified data file will be mapped to the shadow map 308 at some point in time in the future.

In various embodiments, the shadow map module 310 is configured to notify the error module 312 that the shadow map 308 is complete in response to each data file being mapped to the shadow map 308 so that the error module 312 can identify any free bad bits in the shadow map 308. In additional or alternative embodiments, the shadow map module 310 is configured to notify the error module 312 each time that a data file is mapped to the shadow map 308 so that the error module 312 can identify any free bad bits subsequent to each data file being mapped to the shadow map 308. In further additional or alternative embodiments, the shadow map module 310 is configured to notify the error module 312 in response to a modified data file that has already been mapped to the shadow map 308 being updated and/or modified so that the error module 312 can identify any free bad bits resulting from the modification(s) to the modified storage block 302.

An error module 312 may include any suitable hardware and/or software capable of identifying free bad bits for a file system. In various embodiments, the error module 312 is configured to receive the notification(s) from the shadow map module 310 and identify any free bad bits on a file system in response to receiving each notification.

In various embodiments, the error module 312 is configured to utilize the shadow map 308 to identify bad free bits in the block allocation map 306. To identify a bad free bit the in the block allocation map 306, the error module 312 is configured to compare each bit in the shadow map 308 and a corresponding bit in the block allocation map 306. In some embodiments, the error module 312 is configured to pause all write operations while performing the comparing operations and/or functions to ensure that no changes to the file system occur during the comparison.

The error module 312 is configured to identify that a particular bit in the block allocation map 306 is a bad free bit in response to determining that corresponding bits in the block allocation map 306 and the shadow map 308 do not match. Here, the non-match results from the bad free bit in the block allocation map 306 indicating that its corresponding storage block 302 is empty and/or is available to store data (e.g., bad free bit in the block allocation map 306 is turned OFF) and the corresponding bit in the shadow map 308 indicates that the storage block 302 is being used by a data file to store data 304 (e.g., the bit in the shadow map 308 is turned ON). That is, the block allocation map 306 indicates that the storage block 302 is available even though the storage block 302 is actually unavailable, as indicated by the shadow map 308.

In various embodiments, the error module 312 is configured to transmit one or more notifications to the storage block management module 314 in response to identifying any duplicate references in the shadow map 308. The notification(s), in various embodiments, can identify which bit(s) in the shadow map 308 are a duplicate reference. That is, the notification(s) can identify which bit(s) in the block allocation map 306 include a bad free bit (e.g., unavailable storage blocks 302 that are marked available).

A storage block management module 314 may include any suitable hardware and/or software that is capable of managing the storage blocks 302 in the memory device(s) 202. In various embodiments, the storage block management module 314 is configured to receive the notification(s) from the shadow map module 310 and/or the error module 312.

In various embodiments, the storage block management module 314 is configured to prevent any duplicate storage blocks 302 identified in the notification(s) from the shadow map module 310 from being reused while the shadow map module 310 is filling in the shadow map 308 and/or the error module 312 is comparing the shadow map 308 and the block allocation map 306 to identify any bad free bits. That is, the storage block management module 314 is configured to prevent any data from being written to and/or deleted from each identified duplicate storage block 302 while the shadow map module 310 is filling in the shadow map 308 and/or while the error module 312 is comparing the shadow map 308 and the block allocation map 306 to identify any bad free bits.

After the shadow map module 310 has completed filling in the shadow map 308 and/or the error module 312 has completed comparing the shadow map 308 to the block allocation map 306 to identify any bad free bits, various embodiments of the storage block management module 314 are configured to free-up the identified duplicate storage blocks 302 for storing data 304. To free-up a duplicate storage block 302 for storing data 304, the storage block management module 314 is configured to delete reference to the identified duplicate storage block 302 from the metadata of each data file that references the identified duplicate storage block 302. Further, the storage block management module 314 is configured to delete the data 304 from the identified duplicate storage block 302 so that new data 304 can be written to the identified duplicate storage block 302. In certain embodiments, deleting the data 304 from the identified duplicate storage block 302 can include allowing the data 304 that is currently written to the identified duplicate storage block 302 to be written over with new data 304.

In certain embodiments, the storage block management module 314 is configured to transmit one or more notifications to a data file management module 316 (see, FIG. 3B) and/or to a block allocation map module 320 (see, FIG. 3B) in response to deleting the data from one or more storage blocks 302 (e.g., a duplicate storage block 302 or a storage block 302 corresponding to a bad free bit). In various embodiments, each notification can identify each storage block 302 that had its data 304 deleted therefrom.

Referring to FIG. 3C. FIG. 3C is a block diagram illustrating another embodiment of a storage device 202C. A storage device 202C includes a shadow map module 310, an error module 312, and a storage block management module 314 similar to the various embodiments of the storage device 202B discussed with reference to FIG. 3B. At least in the illustrated embodiment, the storage device 202C further includes, among other components and/or elements, a data file management module 316, a correction module 318, and a block allocation map module 320 coupled to and/or in communication with one another and coupled to and/or in communication with the shadow map module 310, error module 312, and storage block management module 314.

A data file management module 316 may include any suitable hardware and/or software that can manage the data files in the file system on the storage device(s) 202. In various embodiments, the data file management module 316 is configured to receive the notification(s) from the storage block management module 314 and perform its operations and/or functions in response to the notification(s).

In various embodiments, the data file management module 316 is configured to determine and/or identify each data file that had data 304 deleted from a storage block 302 identified in the notification(s) received from the storage block management module 314. That is, the data file management module 316 is configured to determine and/or identify each data file that had data 304 deleted from a storage block 302 corresponding to a bad free bit in the block allocation map 306. In additional or alternative embodiments, the data file management module 316 is configured to determine and/or identify each of the two or more data files that reference an identified duplicate storage block 302 and/or are associated with/correspond to a duplicate reference.

In certain embodiments, the data file management module 316 is configured to transmit one or more notifications to the correction module 318 in response to determining and/or identifying each data file that had data 304 deleted from a storage block 302. In various embodiments, each notification can identify each storage block 302 that had data 304 deleted therefrom and the data file corresponding to the deleted data 304 for each bad free bit or each duplicate storage block 302.

A correction module 318 may include any suitable hardware and/or software that can make corrections for one or more data files in the file system stored in one or more storage blocks 302 of the storage device(s) 202. In various embodiments, the correction module 318 is configured to receive the notification(s) from the data file management module 316 and perform its operations and/or functions in response to the notification(s).

The correction module 318, in various embodiments, is configured to determine and/or identify the data 304 that was deleted from each data file when the data 304 was deleted from each storage block 302. In addition, the correction module 318 is configured to obtain (e.g., via one or more backup copies of a data file) the data 304 that was determined/identified as being deleted from a data file. Further, the correction module 318 is configured to write the obtained data 304 to a storage block 302 on the storage device(s) 202 so that the data file is corrected and is again fully or substantially fully written to the storage device(s) 202. Here, the data file(s) are corrected subsequent to the shadow map 308 being filled in and compared to the block allocation map 306 (e.g., after any bad free bits and/or duplicate references are identified and/or determined).

In certain embodiments, the correction module 318 is configured to transmit one or more notifications to the block allocation map module 320 in response to making the corrections. In various embodiments, each notification from the correction module 318 can identify each storage block 302 that had data 304 written to it.

A block allocation map module 320 may include any suitable hardware and/or software than can generate and/or manage a block allocation map 306. In various embodiments, the block allocation map module 320 is configured to receive the notification(s) from the storage block management module 314 and/or the notification(s) from the correction module 318 and perform its various operations and/or functions in response thereto.

In various embodiments, the block allocation map module 320 is configured to mark the block allocation map 306 (e.g., turn one or more bits ON or OFF) to indicate that a storage block 302 has been freed-up in response to receiving each notification from the storage block management module 314 indicating that a storage block 302 has had its data 304 deleted (e.g., has been freed-up for storing data 304). In additional or alternative embodiments, the block allocation map module 320 is configured to mark the block allocation map 306 to indicate (e.g., turn one or more bits ON or OFF) that one or more previously available storage blocks 302 is/are now storing data and/or not available to store data 304 for a different data file.

With reference again to FIG. 2, a processor 204 may include any suitable non-volatile/persistent hardware and/or software configured to perform and/or facilitate performing various processing functions and/or operations. In various embodiments, the processor 204 includes hardware and/or software for executing instructions in one or more modules and/or applications. The modules and/or applications executed by the processor 204 can be stored on and executed from a storage device 202 (e.g., storage device 202A and storage device 202B) and/or from the processor 204 to identify bad free bits and/or duplicate references in a file system and delete data from corresponding storage blocks 302.

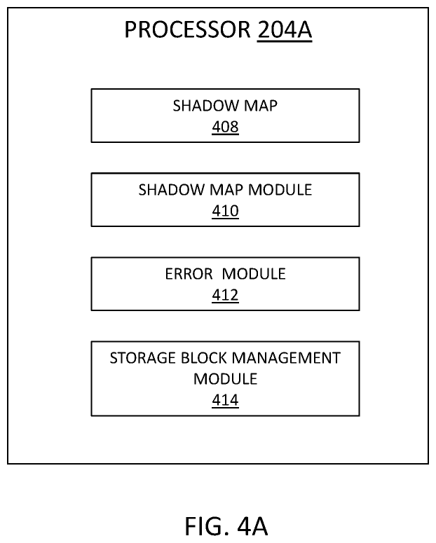

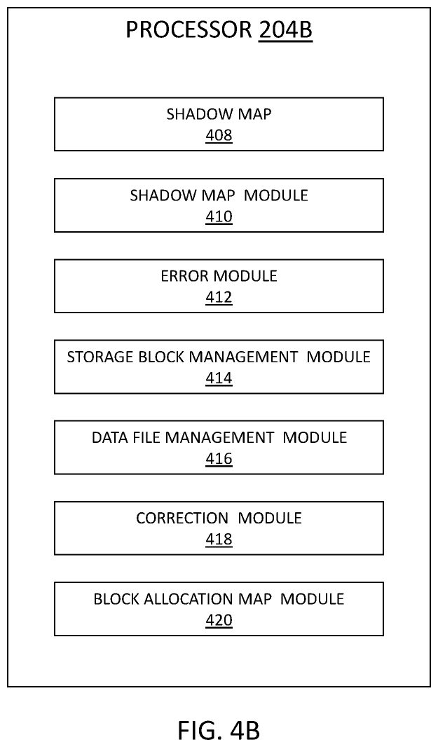

With reference to FIG. 4A, FIG. 4A is a schematic block diagram of one embodiment of a processor 204A. At least in the illustrated embodiment, the processor 204A includes, among other components, features, and/or elements, a shadow map 408 similar to the shadow map 308 included in the storage device 202A discussed with reference to FIG. 3A. The processor 204A further includes a shadow map module 410, an error module 412. and a storage block management module 414 that are configured to operate/function together when executed by the processor 204A to identify bad free bits and duplicate references in a file system similar to the shadow map module 310, error module 312, and storage block management module 314, respectively, in the storage device 202B discussed with reference to FIG. 3B.

Referring to FIG. 4B, FIG. 4B is a schematic block diagram of another embodiment of a processor 204B. At least in the illustrated embodiment, the processor 204B includes, among other components, features, and/or elements, a shadow map 408 similar to the shadow map 308 included in the storage device 202A discussed with reference to FIG. 3A. The processor 204B further includes, among other components and/or elements, a shadow map module 410, an error module 412, a storage block management module 414, a data file management module 416, a correction module 418, and a block allocation map module 420 that are configured to operate/function together when executed by the processor 204B to identify bad free bits and duplicate references in a file system similar to the shadow map module 310, error module 312, storage block management module 314, data file management module 316, correction module 318, and block allocation map module 320, respectively, in the storage device 202C discussed with reference to FIG. 3C.

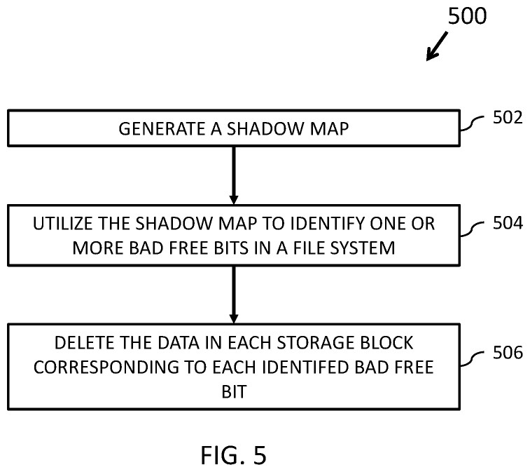

Referring to FIG. 5, FIG. 5 is a schematic flow chart diagram illustrating one embodiment of a method 500 that can utilize a shadow map 308 to identify bad free bits in a file system. At least in the illustrated embodiment, the method 500 can begin by a processor 204A or processor 204B (also simply referred to herein singularly or collectively as, processor 204) generating a shadow map 308 of a file system (block 502).

The method 500 further includes utilizing the shadow map 308 to identify one or more bad free bits in the file system (block 504). In response to identifying each bad free bit in the file system, the method 500 includes deleting the data 304 stored in each storage block 302 corresponding to each bad free bit (block 506).

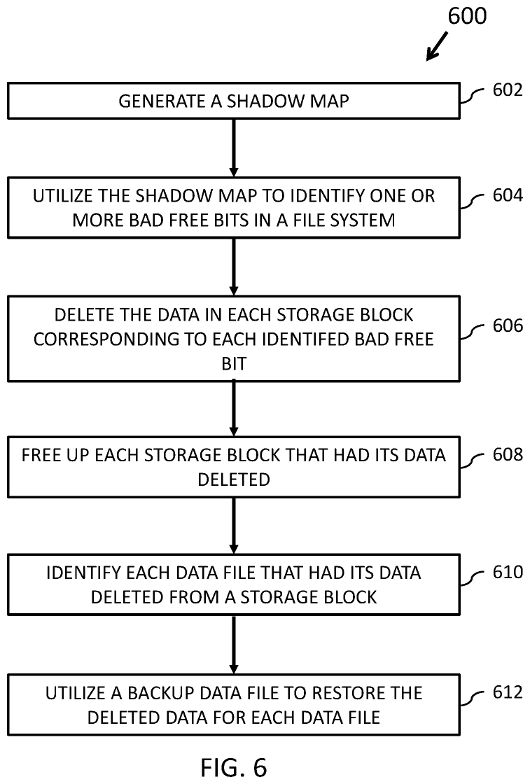

With reference to FIG. 6, FIG. 6 is a schematic flow chart diagram illustrating an embodiment of a method 600 that can utilize a shadow map 308 to identify bad free bits in a file system. At least in the illustrated embodiment, the method 600 can begin by a processor 204 generating a shadow map 308 of a file system (block 602).

The method 600 further includes utilizing the shadow map 308 to identify bad free bits in the file system (block 604). In response to identifying each bad free bit in the file system, data 304 stored in a respective storage block 302 corresponding to each bad free bit is deleted (block 606).

In various embodiments, the method 600 further includes, in response to deleting the data 304 from each respective storage block 302, freeing-up each respective storage block 302 for storing data 304 (block 608). In at least some embodiments, the data 304 is deleted from each respective storage block 302 and each respective storage block 302 is freed up for storing data 304 while the file system remains mounted.

In certain embodiments, generating the shadow map 308 includes locking each data file in the file system at different times. Further, while each data file is respectively locked, generating the shadow map 308 further includes determining each storage block 302 referenced by the metadata in each locked data file and filling in each bit of the shadow map 308, as discussed elsewhere herein.

In additional or alternative embodiments, identifying bad free bits in the file system includes comparing each bit in the shadow map 308 and each bit in a block allocation map 306 to identify each bad free bit in the block allocation map 306. As discussed elsewhere herein, a bad free bit indicates an available storage status in the block allocation map 306 for an unavailable storage block 302 in the storage device(s) 202 (or memory).

In various embodiments, the method 600 further includes identifying each data file that had its respective data 304 deleted from a storage block 302 (block 610). The method 600 also includes utilizing a respective backup data file to restore its respective data 304 to a respective storage block 302 (block 612).

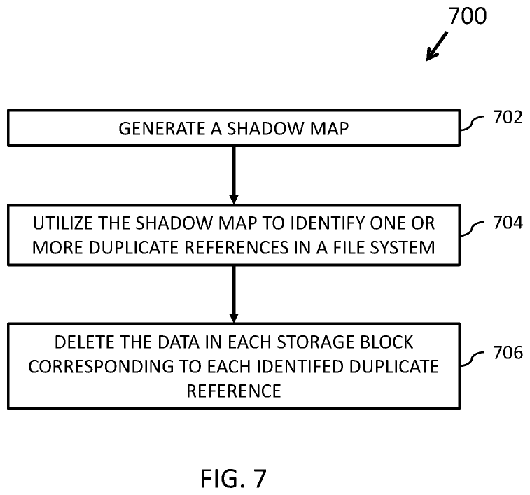

Referring to FIG. 7, FIG. 7 is a schematic flow chart diagram illustrating one embodiment of a method 700 that can utilize a shadow map 308 to identify one or more duplicate references in a file system. At least in the illustrated embodiment, the method 700 can begin by a processor 204 generating a shadow map 308 of a file system (block 702).

The method 700 further includes utilizing the shadow map 308 to identify duplicate references in the file system (block 704). In response to identifying each duplicate reference in the file system, the method 700 includes deleting the data 304 stored in each storage block 302 corresponding to each duplicate reference (block 706).

As discussed elsewhere herein, a duplicate reference (and/or duplicate storage block 302) can be identified and/or determined using the shadow map 308 when the processor 204 goes to turn ON the bit in the shadow map 308 corresponding to a particular storage block 302 indicated in the metadata for a data file that is currently being mapped to the shadow map 308 and the bit is already turned ON and/or has been previously turned ON. That is, a bit in the shadow map 308 that has been previously turned ON is an indication that the metadata for a previously mapped data file is referencing the same storage block 302 as the metadata for a data file that is currently being mapped to the shadow map 308. Specifically, the metadata of the data file that is currently being mapped to the shadow map 308 is referencing the same storage block 302 that the metadata of at least one previously mapped data file is also referencing. In other words, two or more data files include an indication that they are using the same storage block 302 to store data 304.

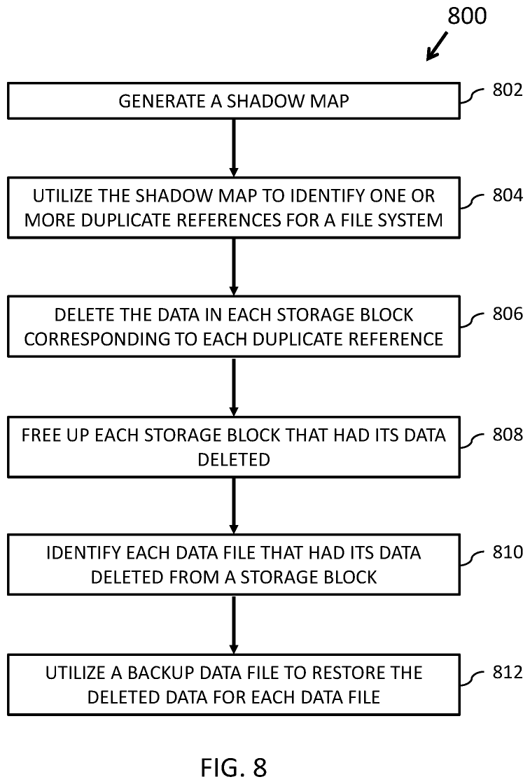

Referring to FIG. 8, FIG. 8 is a schematic flow chart diagram illustrating an embodiment of a method 800 that can utilize a shadow map 308 to identify duplicate references in a file system. At least in the illustrated embodiment, the method 800 can begin by a processor 204 generating a shadow map 308 of a file system (block 802).

The method 800 further includes utilizing the shadow map 308 to identify one or more duplicate references in the file system (block 804), similar to the various embodiments discussed elsewhere herein. In response to identifying each duplicate reference in the file system, the data 304 stored in a respective storage block 302 corresponding to each duplicate reference is deleted (block 806).

In various embodiments, the method 800 further includes, in response to deleting the data 304 from each respective storage block 302, freeing-up each respective storage block 302 for storing data 304 (block 808). In at least some embodiments, the data 304 is deleted from each respective storage block 302 and each respective storage block 302 is freed up for storing data 304 while the file system remains mounted.

In certain embodiments, generating the shadow map 308 includes locking each data file in the file system at different times. Further, while each data file is respectively locked, generating the shadow map 308 further includes determining each storage block 302 referenced by the metadata in each locked data file and filling in each bit of the shadow map, as discussed elsewhere herein.

In additional or alternative embodiments, identifying duplicate references in the file system includes identifying each storage block 302 in the file system that is referenced by at least two different data files. Here, each storage block 302 in the file system that is referenced by at least two different data files can be tagged/flagged as a duplicate reference.

In various embodiments, the method 800 further includes identifying each data file that referenced the same storage block 302 (block 810). The method 800 also includes utilizing a respective backup data file to restore its respective data 304 to a respective storage block 302 (block 812), as discussed elsewhere herein.

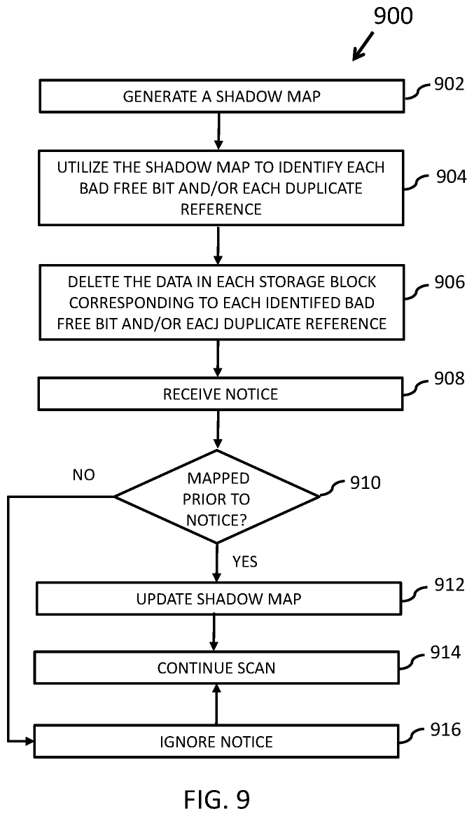

Referring to FIG. 9, FIG. 9 is a schematic flow chart diagram illustrating an embodiment of a method 900 that can utilize a shadow map 308 to identify bad free bits and duplicate references in a file system. At least in the illustrated embodiment, the method 900 can begin by a processor 204 generating a shadow map 308 of a file system (block 902).

The method 900 further includes utilizing the shadow map 308 to identify bad free bits and/or duplicate references in the file system (block 904). In response to identifying each bad free bit and/or duplicate reference in the file system, the data 304 stored in a respective storage block 302 corresponding to each bad free bit or duplicate reference is deleted (block 906).

The method 900 further includes receiving notice that a data file has been modified (block 908) and determining whether the modified data file was mapped to the shadow map 308 prior to receiving the notice (block 910). In response to determining that the modified data file was mapped to the shadow map 308 prior to receiving the notice updating (e.g., a “YES” in block 910), the shadow map 308 is updated with the modification (block 912) and the processor 204 continues to scan the shadow map 308 for bad free bits and/or duplicate references (block 914). In response to determining that the modified data file was not mapped to the shadow map 308 prior to receiving the notice updating (e.g., a “NO” in block 910), the received notice is ignored (block 916) and the processor 204 continues to scan the shadow map 308 for bad free bits and/or duplicate references (block 914).

The embodiments may be practiced in other specific forms. The described embodiments are to be considered in all respects only as illustrative and not restrictive. The scope of the technology is, therefore, indicated by the appended claims rather than by the foregoing description. All changes which come within the meaning and range of equivalency of the claims are to be embraced within their scope.

1. An apparatus, comprising:
a shadow map module that generates a shadow map of a file system; and
at least one of:
an error module that utilizes the shadow map to identify bad free bits in a block allocation map of the file system, and
a shadow map module that utilizes the shadow map to identify duplicate references in the file system.

2. The apparatus of claim 1, wherein the error module is configured to identify the bad free bits by:
comparing each bit of the shadow map to each bit of the block allocation map; and
determining that a bit in the block allocation map is indicated as available and a corresponding bit in the shadow map is indicated as unavailable.

3. The apparatus of claim 1, wherein the apparatus comprises the error module, the apparatus further comprising:
a storage block management module that, in response to identifying each bad free bit, deletes data stored in a respective storage block corresponding to each identified bad free bit.

4. The apparatus of claim 3, further comprising:
a data file management module that identifies each data file that had its respective data deleted from a storage block corresponding to an identified bad free bit; and
a correction module that utilizes a respective backup data file to restore its respective deleted data to a new storage block.

5. The apparatus of claim 1, wherein the shadow map module is configured to identify the duplicate references by:
while mapping a data file to the shadow map, determining that a bit in the shadow map corresponding to a storage block being referenced by a first metadata of the data file that is currently being mapped to the shadow map already indicates that the storage block is being used by a different data file that was previously mapped to the shadow map,
wherein a second metadata of the different data file that was previously mapped to the shadow map also references the storage block corresponding to the bit in the shadow map.

6. The apparatus of claim 5, wherein the storage block management module is further configured to:
prevent each respective storage block that has been identified as having duplicate references from being reused while the shadow map is being filled in.

7. The apparatus of claim 1, wherein the apparatus comprises the shadow map module, the apparatus further comprising:
a storage block management module that, in response to identifying each duplicate reference, deletes data stored in a respective storage block corresponding to each identified duplicate reference.

8. The apparatus of claim 1, wherein, in generating the shadow map, the shadow map module is configured to:
lock each data file in the file system at different times; and
while each data file is respectively locked:
determine each storage block referenced by a metadata of each locked data file, and
mark each bit of the shadow map that is referenced by the metadata of each locked data file as being in use.

9. The apparatus of claim 1, wherein the shadow map module is further configured to:
receive notice that a data file has been modified;
determine whether the modified data file was mapped to the shadow map prior to receiving the notice;
in response to determining that the modified data file was mapped to the shadow map prior to receiving the notice, update the shadow map with the modification and notify the error module of the modification for processing by the error module; and
in response to determining that the modified data file was not mapped to the shadow map prior to receiving the notice, ignore the received notice.

10. A method, comprising:
generating, by a processor, a shadow map of a file system;
utilizing the shadow map to identify bad free bits in a block allocation map of the file system; and
utilizing the shadow map to identify duplicate references in the file system.

11. The method of claim 10, further comprising:
deleting data stored in a respective storage block corresponding to each identified bad free bit and each identified duplicate reference.

12. The method of claim 11, further comprising:
identifying each data file that had its respective data deleted from a storage block corresponding to one of an identified bad free bit and an identified duplicate reference; and
utilizing a respective backup data file to restore its respective deleted data to a new storage block.

13. The method of claim 10, wherein the bad free bits are identified by:
comparing each bit of the shadow map to each bit of the block allocation map; and
determining that a bit in the block allocation map is indicated as available and a corresponding bit in the shadow map is indicated as unavailable.

14. The method of claim 10, wherein the duplicate references are identified by:
while mapping a data file to the shadow map, determining that a bit in the shadow map corresponding to a storage block being referenced by a first metadata of the data file that is currently being mapped to the shadow map already indicates that the storage block is being used by a different data file that was previously mapped to the shadow map,
wherein a second metadata of the different data file that was previously mapped to the shadow map also references the storage block corresponding to the bit in the shadow map.

15. The method of claim 10, wherein generating the shadow map comprises:
locking each data file in the file system at different times; and
while each data file is respectively locked:
determining each storage block referenced by a metadata of each locked data file, and
marking each bit of the shadow map that is referenced by the metadata of each locked data file as being in use.

16. The method of claim 10, further comprising:
receiving notice that a data file has been modified;
determining whether the modified data file was mapped to the shadow map prior to receiving the notice;
in response to determining that the modified data file was mapped to the shadow map prior to receiving the notice, updating the shadow map with the modification and notify the error module of the modification for processing by the error module; and
in response to determining that the modified data file was not mapped to the shadow map prior to receiving the notice, ignoring the received notice.

17. A computer program product comprising a computer-readable storage medium including program instructions embodied therewith, the program instructions executable by a processor to cause the processor to:
generate a shadow map of a file system;
utilize the shadow map to identify bad free bits in a block allocation map of the file system; and
utilize the shadow map to identify duplicate references in the file system.

18. The computer program product of claim 17, wherein the program instructions further cause the processor to:
delete data stored in a respective storage block corresponding to each identified bad free bit and each identified duplicate reference.

19. The computer program product of claim 17, wherein the bad free bits are identified by:
comparing each bit of the shadow map to each bit of the block allocation map; and
determining that a bit in the block allocation map is indicated as available and a corresponding bit in the shadow map is indicated as unavailable.

20. The computer program product of claim 17, wherein:
the duplicate references are identified by, while mapping a data file to the shadow map, determining that a bit in the shadow map corresponding to a storage block being referenced by a first metadata of the data file that is currently being mapped to the shadow map already indicates that the storage block is being used by a different data file that was previously mapped to the shadow map; and
a second metadata of the different data file that was previously mapped to the shadow map also references the storage block corresponding to the bit in the shadow map.
